(19) United States
(12) Patent Application Publication
(10) Pub. No.: US 2005/0283386 A1
(43) Pub. Date: Dec. 22, 2005

(54) Method and system for marketing a treatment regimen

(75) Inventors: Joseph Powers, New Brunswick, NJ (US); William Rehm, Lebanon, NJ (US); Carla Letourneau, Pointe-Claire (CA); Danny Pendleton, Moncton (CA); Stephen Lahaye, Amherstview (CA)

Correspondence Address: SYNNESTVEDT & LECHNER LLP, 2600 ARAMARK TOWER, 1101 MARKET STREET, PHILADELPHIA, PA, 19107-2950, US

(73) Assignee: Aventis Pharmaceuticals Inc., Bridgewater, NJ (US)

(21) Appl. No.: 10/535,376

(22) PCT Filed: Nov. 20, 2003
(86) PCT No.: PCT/US03/37214

§ 371 Date: May 19, 2005

Related U.S. Application Data
(60) Provisional application No. 60/427,771, filed on Nov. 20, 2002.

(51) Int. Cl. G06Q 10/00

(52) U.S. Cl. 705/3; 705/2

(57) ABSTRACT

A software program, for use on a computing device such as a Personal Digital Assistant (PDA) device, is provided to a health care provider (HCP). The software program configures the computing device with means for inputting profile information regarding patients and means for comparing the patient profile information against a database containing information regarding one or more drug studies performed on patients having similar medical histories and/or symptoms. The patient information is compared against the database, and, where appropriate, the healthcare provider is made aware that the patient associated with the patient profile could benefit from being prescribed to take the drug or drugs on which the study is based, and/or at a particular dose indicated by the study.

### CROSS-REFERENCE TO RELATED APPLICATIONS

This application is based on and claims priority to U.S. Provisional Application No. 60/427,771, filed Nov. 20, 2002, fully incorporated hereinby reference.

### BACKGROUND OF THE INVENTION

1. Field of the Invention

The present invention relates generally to health care, and particularly to a method and system for marketing a particular treatment regimen to health care providers.

2. Description of the Related Art

Physicians, nurses, physical therapists, physical trainers and other health care providers (collectively “health care providers” or “HCP”) often have occasion to prescribe a treatment such as a medication, physical therapy, or exercise regimen to a patient. Such treatments are typically administered to treat a malady, disease, or other physical condition. For example, a physician may prescribe a drug regimen to treat a patient having one or more cardiovascular risk factors such as coronary artery disease, peripheral vascular disease, hypertension, elevated cholesterol level, to name a few. Patients who have a history of such risk factors face an increased likelihood of developing angina, heart failure, myocardial infarction, strokes, or many other life-threatening conditions. In view of these significant life-threatening conditions, significant research is directed to the development of treatment regimens, particularly pharmaceuticals, that will reduce the likelihood that these cardiovascular risk factors will progress to the point where they become life-threatening.

It is well known that drugs are subjected to rigorous studies, both for approvals for use by humans (e.g., FDA approval) or for research purposes to evaluate the effectiveness of a particular drug for treatment of a particular condition. Frequently, such studies indicate that the drug under evaluation performs very well for the treatment of the particular condition. In addition, sometimes these studies identify other characteristics of the drug that were previously unknown, e.g., that a higher or lower dose than that which is ordinarily recommended gives better results than was known before the study. As an example, the drug RAMIPRIL, an angiotensin-converting-enzyme inhibitor, was already known to improve the outcome of patients with left ventricular dysfunction. However, RAMIPRIL was subjected to extensive testing in a test called the Heart Outcomes Prevention Evaluation study (referred to as the “HOPE study”) to assess the role of RAMIPRIL in patients who were at high risk for cardiovascular events but who did not have left ventricular dysfunction. This study, performed using over 9,000 test subjects, indicated that RAMIPRIL “significantly reduces the rates of death, myocardial infarction, and stroke in a broad range of high risk patient who are not known to have a low ejection fraction or heart failure” (New England Journal of Medicine, Vol. 3042, No. 3, pp. 145-153 (Jan. 20, 2000)). The HOPE Study also revealed that in some cases, a patient benefitted from a 10 mg dose instead of the recommended 5 mg dose.

Such studies, i.e., an independent study indicating that a particular drug has significantly positive results on a particular population of patients, can be very valuable to the manufacturer of the studied drug. However, translating these positive results to increased sales of the product, while quite desirable for the pharmaceutical manufacturer, can be very difficult. The positive results must be highly publicized and health care providers must be made aware of the study and its positive conclusions, and to be most effective as a marketing tool, they should be reminded of these positive results on a regular basis.

Accordingly, it would be desirable to have a method of marketing pharmaceuticals whereby the positive results of a particular study are provided to a health care provider on a regular basis, particularly at a time when the health care provider is prescribing a treatment to a patient who would benefit from using the drug that was the subject of the study.

### SUMMARY OF THE INVENTION

The present invention is a method and system of marketing a particular drug based upon, among other factors, its positive evaluation in medical studies of the drug on a patient population. In general, the invention comprises the comparison of patient profile information (e.g., medical history, diagnosis, physical parameters, pre-existing conditions, etc.) with data developed during the study of the particular drug. If the results of the comparison indicate that the patient is likely to benefit from the use of the particular drug, then the health care provider making the comparison is alerted to the availability of the particular drug and its beneficial uses for the patient. Particular treatment regimens indicated by the comparison can also be presented to the healthcare provider as a most desirable treatment option.

In a preferred embodiment, a software program, for use on a computing device such as a Personal Digital Assistant (PDA) device, is provided to the health care provider. The software program configures the computing device with means for inputting profile information regarding patients and means for comparing the patient profile information against a database containing information regarding one or more drug studies performed on patients having similar medical histories and/or symptoms. The patient information is compared against the database, and, where appropriate, the healthcare provider is made aware that the patient associated with the patient profile could benefit from being prescribed to take the drug or drugs on which the study is based, and/or at a particular dose indicated by the study. In this manner, a pharmaceutical manufacturer having drugs that have demonstrated positive results in studies is able to present to the HCP information indicating the desirability of prescribing their particular drug whenever a patient is indicated as possibly benefitting from use of the drug.

### BRIEF DESCRIPTION OF THE DRAWINGS

FIG. 1 illustrates an example of an environment in which the present invention may operate;

FIG. 2 is a flowchart illustrating the basic steps performed in accordance with the present invention; and

FIG. 3 is a flowchart illustrating an example of the steps performed in the comparison of patient profile information with data from a particular study.

### DETAILED DESCRIPTION OF THE PREFERRED EMBODIMENTS

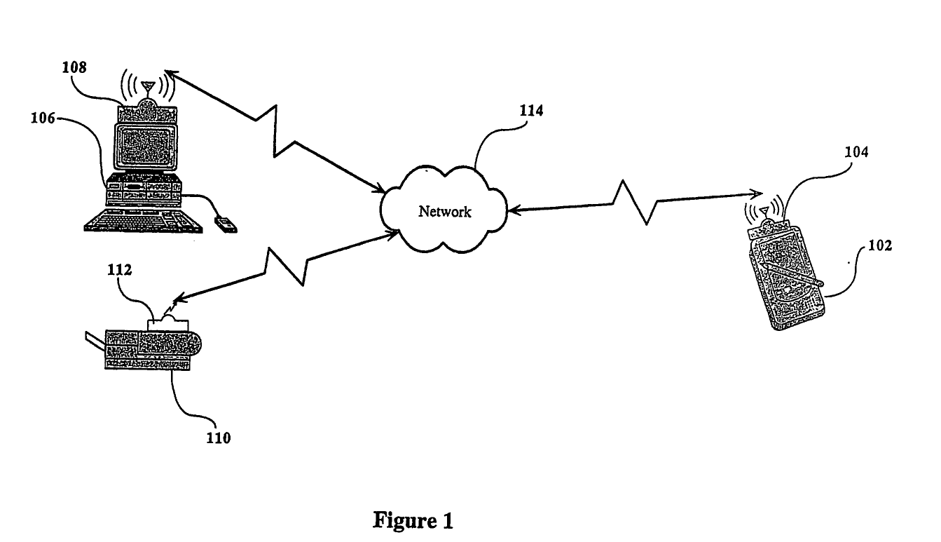

FIG. 1 illustrates an example of an environment in which the present invention may operate. It is understood that this environment is illustrated for purposes of example only and that numerous other configurations will be apparent to those of ordinary skill in the art in view of the disclosure herein.

Referring to FIG. 1, a computing device 102 is in communication with a processor/storage device 106 and a printing device 110. In the example of FIG. 1, a hand-held computing device 102 such as a Personal Digital Assistant (PDA) is shown configured for wireless communication via a wireless transceiver 104. Processor/memory device 106 comprises a personal computer (e.g., an IBM NetVista™ computer) configured for wireless communication via a wireless transceiver 108. Printing device 110 comprises a laser printer configured for wireless communication via a wireless transceiver 112. In the embodiment illustrated in FIG. 1, the illustrated devices communicate with each other wirelessly via a network 114. It is understood that numerous other well known means of providing communication between these devices can be provided. For example, processing/memory device 106 can be cable-connected to printing device 110, and the computing device 102 can communicate with the processor/memory device 106 via a cradle which enables a hot-sync operation between the computing device 102 and processor/memory device 106 as is well known. Infrared and/or wired communication can also be utilized to provide connectivity between the devices.

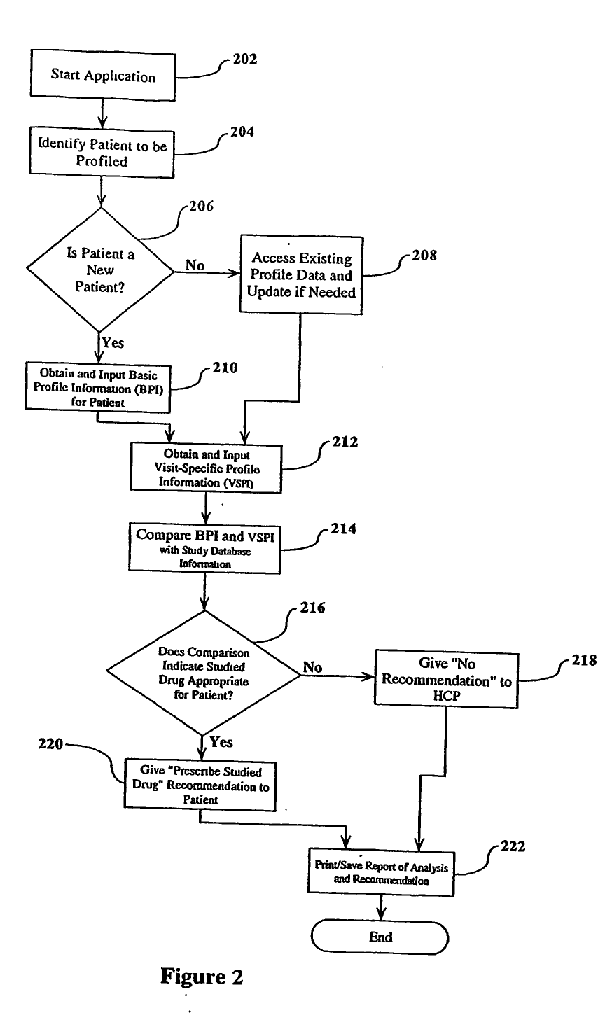

In accordance with the present invention, computing device 102 stores a software application (not shown) which enables an HCP to input and store data pertaining to patients of the HCP. The software application, described more fully herein with respect to FIG. 2, below, presents the HCP with a series of questions to elicit Basic Profile Information (BPI) for patients. The BPI includes general data that is typically obtained for all patients, including name, address, age, sex, height, weight, smoker/non-smoker, and the like. In the preferred embodiment, the software program is given to the HCP via download from the Internet, by “beaming” it to the HCP's PDA in a well-known manner, or using any other known method of delivery of software to a computing device.

In addition to the above-described features, the software application also provides the HCP with the ability to obtain Visit-Specific Profile Information (VSPI) for each patient whenever that patient is examined by the HCP. The VSPI is more specific to the symptoms and/or condition of the patient at the time of a visit to the HCP's office or facility. If desired, the VSPI can also include a solicitation for the HCP to update the previously obtained BPI (e.g., height, weight, and other such statistical information that could change from time to time).

In accordance with the present invention, the software program stored on computing device 102 has access to at least one database containing data specific to a particular study for a particular drug. For the purpose of this application, the information contained in this database is referred to as the “Study Database Information” and the particular drug that is the subject of the study is referred to as the “Studied Drug”.

In accordance with the present invention, the software application is configured to compare both the BPI and the VSPI with the Study Database Information to determine if the profile information of a particular patient would indicate that the Studied Drug would be appropriate for use by the patient. If the results of the comparison indicate that the Studied Drug would not be appropriate for the patient, the HCP is given no recommendation regarding drugs to prescribe to the patient. If, however, the results of the comparison indicate that the particular patient would benefit from taking the Studied Drug, then the HCP is given an indication as to the drug and dosage. This enables the Studied Drug to be presented to the HCP as a favored option whenever one of the HCP's patients presents indications that use of that drug would be beneficial. This will result in more patients obtaining the beneficial effects of the drug, and will generate more sales of that drug for the manufacturer.

FIG. 2 is a flowchart illustrating the basic steps performed by the software application stored on computing device 102. At step 202, the application is started in any known manner, for example, by tapping an icon on a PDA that stores the application. At step 204, the HCP identifies the patient to be profiled, e.g., by manually entering the patient's name or by selecting the patient's name from a list. In some cases, the patient will already be in the system; in other cases, the patient will be a new patient and will need to be identified as such. At step 206, a determination is made as to whether or not the patient is a new patient. If the patient is determined not to be a new patient, the process moves to step 208 where the existing profile data is retrieved and, if needed, the HCP is given the opportunity to update the BPI for the existing patient.

If, at step 206, it is determined that the patient is a new patient, then at step 210, the physician is presented with a series of questions and/or “fill-in-the-blank” fields that solicit the BPI for the new patient. This information can be input by any known means, e.g., via a keyboard or by hard-writing the information using the handwriting recognition capability available on many PDAs (e.g., Graffiti®).

The process then proceeds to step 212, where additional questions/fields are presented to the HCP to solicit the VSPI relative to the current visit. For example, to identify issues related to hypertension, the HCP will be directed to obtain values for systolic blood pressure, diastolic blood pressure, left Ankle-Brachial Index (ABI), right ABI, total cholesterol level, HDL cholesterol level, LDL cholesterol level, and triglyceride level.

Next, the HCP could be presented with a diabetes screen, where input of urinalysis data, creatinine clearance, proteinuria, microalbuminuria, ALB/CREAT. ratio, and other diabetes-related information could be requested. The same process can be performed for any information needed relevant to that visit, for example, to elicit information regarding glucose control measures being taken by the patient or to identify what current medications the patient is taking, and the physician can be given the opportunity to input notes about the visit for record-keeping purposes.

Once all of the VSPI has been obtained and input to the application, at step 214, the BPI and VSPI data is compared with the Study Database Information to determine if, based upon the BPI and VSPI, the study would indicate that the Studied Drug would be appropriate for that patient. If, at step 216, a determination is made that the Studied Drug would not be appropriate for the patient, at step 218, the computing device displays an indication that there is no recommendation to be made at this time.

If, however, at step 216, the comparison indicates that the Studied Drug would be appropriate for the patient, then at step 220, the HCP is given an on-screen recommendation that the Studied Drug would be appropriate for this patient, and the dosage and instructions for use of the drug for that patient are also given to the HCP. At step 222, the results of the analysis performed by the application can be stored and/or saved in report form for later viewing and/or for giving to the patient. At this point the process ends.

It is contemplated that the software application installed on the computing device can be a valuable assessment tool for the HCP, which will encourage its use by the HCP. To further enhance the usefulness of the software application and further encourage its use, additional features may be included. For example, the current generation of PDAs include significantly more powerful processors than were used in early versions of PDAs. This makes it possible to utilize the triple data encryption standard (triple DES) to encrypt the patient data and thereby assure that confidential information stored on the PDA is safe from disclosure to unauthorized individuals or organizations. In addition, calculation functions can be included so that, for example, an ABI calculator, BMI calculator, or any other calculator can be included, giving the HCP the ability to easily calculate values of interest based upon BPI and VSPI data already gathered and stored in connection with the use of the software application. “Hot-sync printing” can also be made available, so that once the HCP hot-syncs their PCA device to their desktop PC, the software application can generate any reports that have been “queued” by the HCP and send them immediately to the printer to be printed. Various other features, such as the ability to display data relating to multiple patient visits by providing “tab access” to the multiple visit data (i.e., if a patient has made four visits, four “tabs” will appear on the screen, each being accessible by tapping on the appropriate tab with a stylus) can be made available.

In a preferred embodiment, the software application is configured to be completely operable from a PDA, without any need to access other peripheral devices unless printing and/or external storage (e.g., hot-syncing) is desired or needed. Thus, in a preferred embodiment, all data, including the Study Database Information and patient data (e.g., BPI and VSPI) is stored directly on the PDA and is accessible to or integrated into the software application. However, it is understood that stored elements, such as the Study Database Information and/or BPI and VSPI, can be stored externally and accessible via network connections or the like. Thus, for example, all data to be used by the software application stored on the PDA can be transferred to the processor/storage device 206 via wireless connection, wired network connection, and the like, depending upon the needs of the HCP and the technology available to the HCP.

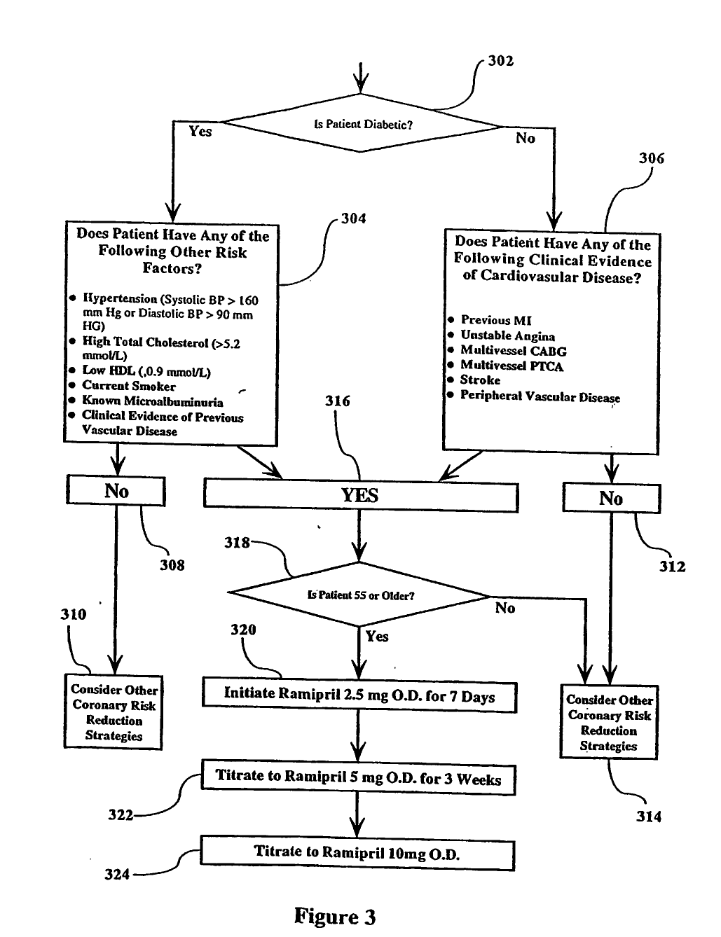

FIG. 3 is a flowchart illustrating an example of the steps performed in step 214 of the flowchart of FIG. 2 (comparison of patient profile information with Study Database Information). The example illustrated in FIG. 3 is directed to the HOPE study. It is understood that this is illustrated for the purpose of example only, and that any study data can be utilized in a similar manner. As will be clear from FIG. 3, the general concept involves the identification of threshold values related to study/patient characteristics and determining if a new patient meets one or more of the thresholds. Depending upon the results of the study and the characteristics of a patient whose profile information is being compared to the studied data, a recommendation for the patient to take the Studied Drug may or may not be given to the HCP.

The HOPE study is useful for analysis of the condition of patients who are already known to be diabetic and/or who have clinical evidence of cardiovascular disease. Referring to FIG. 3, at step 302 a determination is made as to whether or not the patient under evaluation is diabetic. If it is determined that the patient is diabetic, then the profile information of the patient is analyzed to determine if any other risk factors that were evaluated in the HOPE study are present in the patient. For example, at step 304, if it is determined that the patient does not have any of the other risk factors listed in step 304 (as indicated by the “NO” determination of step 308), then the process proceeds to step 310, where no recommendation is given to the physician except possibly to consider other coronary risk reduction strategies other than use of RAMIPRIL, which is the subject of the HOPE study. Similarly, if it is determined that the patient is not diabetic at step 302, and at step 306 it is determined that the patient does not have any of the listed clinical evidence of cardiovascular disease (as indicated by the “NO” determination of step 312), the process likewise proceeds to step 314 and the HCP is directed to consider other coronary risk reduction strategies other than RAMIPRIL.

However, if at either of steps 304 or 306, it is determined that the patient possesses one or more of the listed parameters (e.g., a systolic blood pressure greater than the threshold level of 160 mm Hg (step 304) or a previous myocardial infarction (step 306) then the process proceeds to step 316 (a “YES” determination) and then it is determined at step 318 if the patient is 55 or older.

In the case of the HOPE study, the determination as to whether or not the patient is 55 or older is required because the study was limited to patients of 55 or older, and thus FDA or other government approvals may only allow a recommendation based on the positive results of the HOPE study if the patient falls within the test parameters. This does not prohibit a physician or HCP from prescribing RAMIPRIL for a patient under 55 years of age; it simply means that the drug manufacturer providing the software to the HCP cannot recommend the use of that drug to someone below the age threshold of the study (55 in the case of the HOPE study).

Thus, if at step 318 it is determined that the patient is not 55 or older, the process proceeds to step 314 where the HCP is advised to consider other coronary risk reduction strategies. However, if at step 318 it is determined that the patient is 55 or older, then at step 320 the HCP is given a recommendation to initiate RAMIPRIL at a level of 2.5 mg O.D. for 7 days, followed at step 322 with a recommendation to titrate to RAMIPRIL 5 mg O.D. for three weeks, followed at step 324 by a recommendation to titrate to RAMIPRIL 10 mg O.D. These are the recommended dosages/titrations resulting from the HOPE study.

As can be seen, through the use of the software application provided to the HCP, wherever appropriate a recommendation can be given to the HCP that the Studied Drug (in the example of FIG. 3, RAMIPRIL) be prescribed to the patient. Each time the HCP uses the software application as an assessment tool, this recommendation will be given where appropriate.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage of a PDA. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-3 support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of any claims appended hereto.

1. A processor-implemented method of marketing a treatment regimen that is the subject of a study, comprising the steps of:
comparing, using a processing device, patient profile information for one or more patients with study data pertaining to said treatment regimen;
recommending a specific treatment regimen for one or more of said patients whose patient profile information was subjected to said comparison step, based on said comparison results; and
outputting said comparison results.

2. The method of claim 1, further comprising the steps of:
gathering said patient profile information; and
storing said patient profile information in a memory accessible by said processing device.

3. The method of claim 2, further comprising the steps of:
gathering said study data pertaining to said treatment regimen; and
storing said study data in a memory accessible by said processing device.

4. The method of claim 3, wherein said study data comprises data from the Heart Outcomes Prevention Evaluation (HOPE) study.

5. The method of claim 3, wherein said processing device comprises a PDA.

6. The method of claim 2, wherein said step of gathering patient profile information comprises at least the steps of:
obtaining basic profile information for each of said one or more patients; and
obtaining visit-specific profile information for each of said one or more patients.

7. A system for marketing a treatment regimen that is the subject of a study, comprising:
a processor, configured to:
compare patient profile information for one or more patients with study data pertaining to said treatment regimen; and
identify a specific treatment regimen for one or more of said patients based on said comparison results; and
an output device, coupled to said processor, for displaying said recommended treatment regimen.

8. The system of claim 7, further comprising:
an input device, coupled to said processor, for inputting said patient profile information; and
a storage device, coupled to said processor, for storing said patient profile information.

9. The system of claim 8, wherein said input device includes:
means for inputting study data pertaining to said treatment regimen; and
a storage device for storing said study data.

10. The system of claim 9, wherein said study data comprises data from the Heart Outcomes Prevention Evaluation (HOPE) study.

11. The system of claim 9, wherein said processor comprises a PDA.

12. A computer program product recorded on computer-readable medium for marketing a treatment regimen that is the subject of a study, comprising:
computer-readable means for comparing patient profile information for one or more patients with study data pertaining to said treatment regimen;
computer-readable means for recommending a specific treatment regimen for one or more of said patients whose patient profile information was subjected to said comparison step, based on said comparison results; and
computer-readable means for outputting said comparison results.

13. The computer program product of claim 12, further comprising:
computer-readable means for gathering said patient profile information; and
computer-readable means for storing said patient profile information in a memory accessible by said computer-readable means for comparing patient profile information.

14. The computer program product of claim 13, further comprising:
computer-readable means for gathering said study data pertaining to said treatment regimen; and
computer-readable means for storing said study data in a memory accessible by said computer-readable means for comparing patient profile information.

15. The computer program product of claim 14, wherein said study data comprises data from the Heart Outcomes Prevention Evaluation (HOPE) study.

16. A system for marketing a treatment regimen that is the subject of a study, wherein data pertaining to the study of said treatment regimen is stored in a study database, comprising:
a recording device configured to solicit patient profile information for one or more patients;
a storage device, coupleable to said recording device, storing said patient profile information; and
a processor configured to:
compare said patient profile information with said study data stored in said study database; and
issue a recommendation recommending said treatment regimen for each patient having patient profile information that indicates, based on said comparison with said study data, a benefit to be gained from said treatment regimen.
